(19) United States
(12) Patent Application Publication
(10) Pub. No.: US 2019/0147535 A1
(43) Pub. Date: May 16, 2019

(54) TRADE DATA PROCESSING DEVICE AND METHOD FOR FINANCIAL INSTRUMENTS

(71) Applicant: HAN-MING HSIEH, HSINCHU CITY (TW)

(72) Inventor: HAN-MING HSIEH, HSINCHU CITY (TW)

(21) Appl. No.: 15/809,201

(22) Filed: Nov. 10, 2017

(51) Int. Cl. G06Q 40/06

(52) U.S. Cl. CPC G06Q 40/06

(57) ABSTRACT

A trade data processing device for financial instruments having a financial information receiving module, a price-and-volume displaying module displaying multiple price-and-volume information messages of financial information; a customized combination module generating multiple information options and allowing a user to select and generate combination information message, the featured-price-and-volume level module defining a featured price to generate multiple featured-price-and-volume level information messages to the combining-and-generating module according to the volume-defining level information message of the combination information message such that the multiple featured prices level bars are combined to form a featured-price-and-volume block, a featured-price-and-volume block information message is generated to the information displaying module to generate a comprehensive-featured price-and-volume block chart. The trade data processing device effectively assists an investor to invest.

### FIELD OF THE INVENTION

The present invention relates to a technology for analyzing price fluctuation of financial instruments, especially to a trade data processing device for financial instruments and a method thereof.

### BACKGROUND OF THE INVENTION

In trade, currency, bonds, stocks, futures, options, Exchange Traded Funds (ETF), hedge funds, etc. are collectively called financial instruments. Prices movement of financial instruments often fluctuate with the environment of the market and vary in form of fluctuation. These fluctuations of price movement were generally divided into advancing trend, declining trend and consolidation period. Price movements would most probably lead to advancing trend or declining trend whenever it escapes from the consolidation period. And price movement either in advancing trend or in declining trend would be probably retarded whenever it encounters consolidation period. Therefore, effectively analyzing trade data of financial instruments to discover the consolidation period of price movement then to facilitate buying and selling the financial instruments on the right time becomes an issue of paramount importance for investors.

In general, in a displayed option menu of a conventional tape-reading and strategic-decision-making system of investing or trading financial instruments, pages with all function options are illustrated so as to provide needed information message according to users' choices. Function options such as indexes, stock quotes, optional quotes, financial news, basic analysis, chip analysis, technical analysis, etc. after a needed function tab is pressed, the tape-reading and strategic-decision-making software may be switched to change a view thereof so as to allow an investor to check the information message corresponding to the chosen function.

However, in analyzing functions of the conventional tape-reading and strategic-decision-making system of investing or trading financial instruments, only resistance featured price or support featured price of one-dimensional consideration is provided, the one-dimensional consideration may be a consideration of historical trade prices or may be a consideration of historical trade volumes to define a resistance featured price or a support featured price. With only one-dimensional consideration of the historical trade prices, the price peak that is difficult to break through is a so-called resistance featured price. On the other hand, when the price is lowered to the price valley that is difficult to break through, such price valley is a so-called support featured price. In detail, with reference to FIG. 1, in the price line chart, connecting “at least two of the lowest price points” and extending the connecting line toward the right side of the price line chart forms a “support line”. Connecting “at least two of the highest price points” and extending the connecting line toward the right side of the price line chart forms a “resistance line”. Alternatively, the price of the maximum trade volume is defined as the resistance price or the support price. These conventional technologies respectively consider only the information message of the historical trade price of the financial instruments or only the information message of the historical trade volumes of the financial instruments. In addition to manually depicting the resistance line or support line, the information message of strategic decision making for investment provided by the conventional technologies is somewhat wear and insufficient. For example, neither the bliss point of price after the resistance line or the support line broken through nor start point or stop point of the price advancing or declining can be offered by such conventional technologies such that limited assistance of strategic decision making of the conventional technologies is provided to the investors. Movement of prices change of financial instruments are generally classified into an advancing trend, a declining trend, and a consolidation period The prices of financial instruments changes in each trend in form of fluctuation and prices movement of the financial instrument has a specific price block or featured price block. A boundary line of the featured price block plays a role as a start point or a stop point of the advancing trend or declining trend. The featured price block also represents both the stalemate and chaos in the consolidation period of the price movement fluctuation of the financial instruments, and therefore, finding and discovering financial instruments featured price block is of paramount importance to investment. It makes an investor to read out clearly and effectively allows the investor to make decision according to the conditions on current stage such that investment profit is increased significantly. However, a conventional tape-reading and strategic-decision-making system of financial instruments does not develop such technology of finding and discovering financial instruments featured price block.

For the reasons mentioned above, the present invention, aimed at the shortcomings of the conventional technologies, provides a trade data processing device and method for financial instruments to effectively overcome the aforementioned problems.

### SUMMARY OF THE INVENTION

The primary objects of the present invention is to provide a trade data processing device for financial instruments and trade data processing method for financial instruments that jumps out of the technical analyzing function of a conventional tape-reading and strategic-decision-making system of financial instruments merely providing the featured price of one-dimensional consideration, the one-dimensional consideration or the only consideration of the historical trade price to define the resistance or support featured price. Alternatively, the technical analyzing function of the conventional tape-reading and strategic-decision-making system of financial instruments only employs the consideration of the historical maximum trade volume to define the resistance or support featured price. The present invention synchronously combines the past information messages of historical trade price and historical trade volume of the financial instruments that takes completely two-dimensional data into account. By two quantization processes, the two-dimensional data is turned into a featured-price-and-volume block information message. The featured-price-and-volume block information message indicates a consolidation period of price fluctuation of the financial instruments. The price fluctuation indicates stalemate and chaos. When the price fluctuation of the financial instruments is escaping from the featured price-and-volume block, it is deemed as price movement no matter which of a start point or stop point of an advancing trend or declining trend the price fluctuation undergoes, which effectively assists investors and enhances investing profit of the financial instruments.

Another object of the present invention is to provide a trade data processing device for financial instruments and a method thereof that is able to add weighting factor of relative trade volume according to different characteristics of trading objects of various financial instruments, provides more precise information messages to enhance investing profit of the financial instruments.

To achieve the aforementioned objective, the present invention provides a trade data processing device for financial instruments used in a computer with a display, and the trade data processing device for financial instruments comprises an information receiving module receiving at least one external financial information message of the financial instruments; a price-and-volume displaying module displaying multiple price-and-volume information messages of the financial instruments according to the financial information message; a customized combination module generating multiple displayed information options, and displaying the multiple displayed information options in a display of the computer to allow a user to select at least one of the displayed information options to generate a combination information message, wherein the combination information message comprises a trade volume-defining level information message; a featured-price-and-volume level module receiving multiple price-and-volume information messages and the combination information message generated by the customized combination module, and the featured-price-and-volume level module, according to the trade volume-defining level information message of the combination information message, defining a price-and-volume information message being larger than a predetermined value of a trade volume condition as a featured price to generate a featured-price-and-volume level information message to a combining-and-generating module, then the combining-and-generating module combining the multiple featured prices level bars to form a featured-price-and-volume block to generate at least one combined featured-price-and-volume block information message; finally transmitting the financial information message, the featured-price-and-volume level information message and the combined featured-price-and-volume block information message to an information displaying module such that the information displaying module generates a comprehensive featured-price-and-volume block chart shown on the display according to the featured-price-and-volume level information message and the featured-price-and-volume block information message.

Furthermore, the present invention also provides a trade data processing method for financial instruments comprising the following steps. First, an activating signal is transmitted such that at least one financial information message of the financial instruments is received according to the activating signal, and multiple price-and-volume information messages of the financial instruments are displayed according to the financial information message; multiple displayed information options are generated such that at least one of the displayed information options is selected and a combination information message, combination information message including a trade volume-defining level information message is generated; defining the price-and-volume information message being larger than a predetermined value of a trade volume condition as a featured price according to the volume-defining level information message to generate a featured-price-and-volume level information message; combining the multiple featured prices level bars to form a featured-price-and-volume block to generate at least one combined featured-price-and-volume block information message; finally, generating a comprehensive featured-price-and-volume block chart according to the financial information message, the featured-price-and-volume level information message and the combined featured-price-and-volume block information message.

Detailed descriptions are presented by embodiments as follows. Hereby the objectives, technical contents, features and achieved effects of the present invention will be more easily understood.

### DESCRIPTION OF THE DRAWINGS

FIG. 1 is a schematic view of conventional resistance and support featured prices;

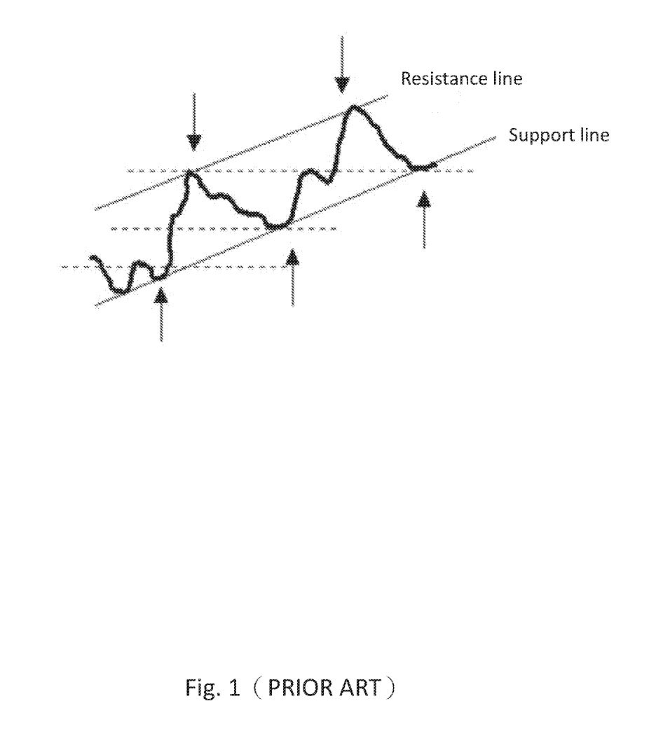

FIG. 2 is a schematic view of a block diagram for a system of the present invention;

FIG. 3 is a schematic bar chart view of a price-and-volume information message of the present invention;

FIG. 4 is a schematic view of the marked featured price of the present invention.

FIG. 5 is a schematic level bar chart view of the featured-price-and-volume level information message of the present invention;

FIG. 6 is a schematic block chart view of a combined featured-price-and-volume block information message of the present invention;

FIG. 7 is a schematic view of the weighted price-and-volume information message of the present invention;

FIG. 8 is a schematic view of a long-term average price information message of the present invention;

FIG. 9 is a schematic view of a flowchart of a method of the present invention;

FIG. 10 is a schematic view of displayed information options of the present invention;

FIG. 11 is a schematic weighted bar chart view of the marked weighted featured price of the present invention;

FIG. 12 is a schematic weighted level bar chart view of the weighted featured-price-and-volume level information message of the present invention;

FIG. 13 is a schematic weighted block chart view of the weighted combined featured-price-and-volume block information message of the present invention; and

FIG. 14 is a schematic view of a comprehensive featured-price-and-volume block chart of the present invention.

### DETAILED DESCRIPTION OF THE PREFERRED EMBODIMENTS

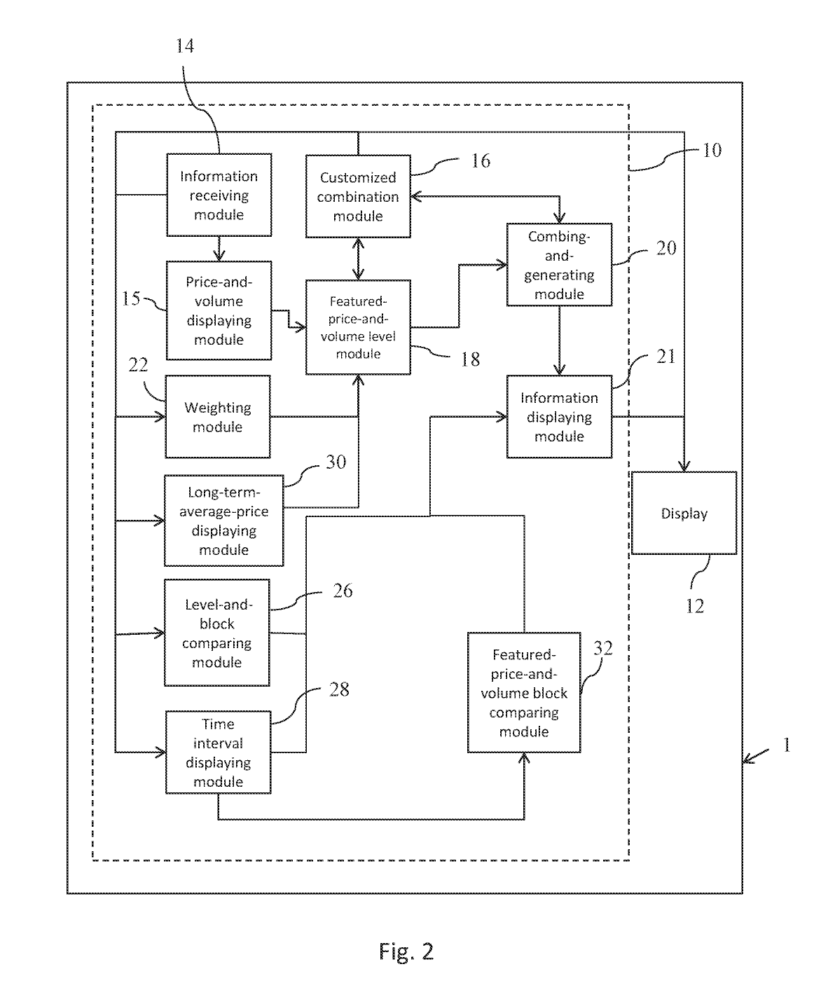

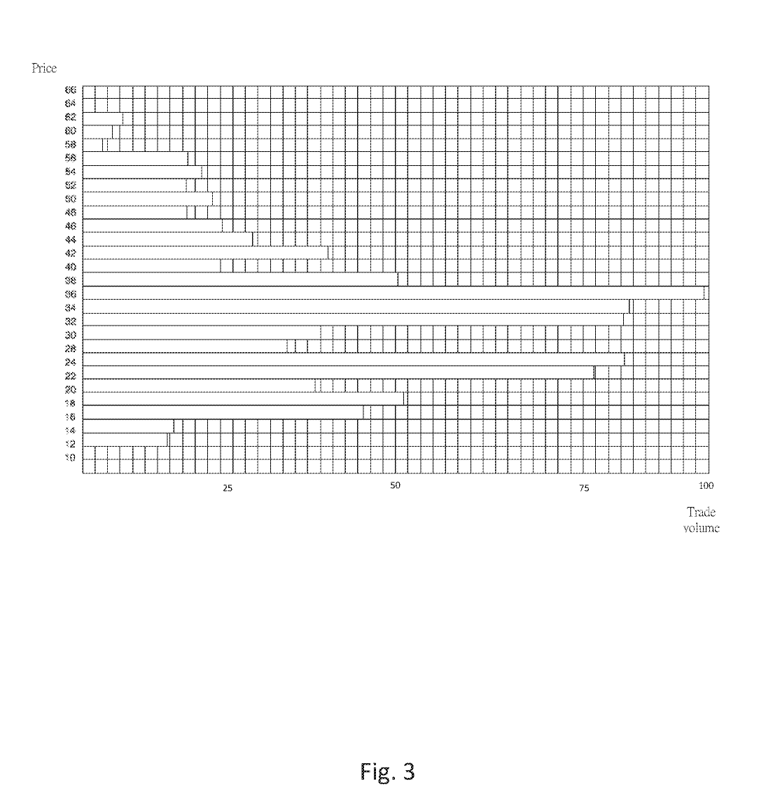

With reference to FIG. 2, as shown in the figure, a trade data processing device for financial instruments in accordance with the present invention is used in a computer 1. The computer 1 comprises a processing unit 10 and a display 12. The trade data processing device for financial instruments in accordance with the present invention is disposed in the processing unit 10 and comprises an information receiving module 14 for receiving a financial information message of at least one external financial instrument. The information receiving module 14 may be a wired or wireless signal receiver to receive wired or wireless signals. The financial instruments are stocks, currency, bonds, options, futures, Exchange Traded Funds (ETF) or interest rates, etc. The information receiving module 14 is electrically connected to a price-and-volume displaying module 15 such that the information receiving module 14 transmits the financial information message to the price-and-volume displaying module 15, and then displays multiple price-and-volumes according to multiple price-and-volume information messages of the financial information message. A displayed price-and-volume is shown as a bar chart in FIG. 3, according to each price-and-volume of the financial instruments, distributed bar graphics are presented. Each bar graphic in the chart indicates a different price interval, a length of the bar graphic indicates trade volume. A customized combination module 16 is electrically connected to the display 12 to generate multiple displayed information options and displays the displayed information options in the display 12 to allow a user to select at least one of the displayed information options. The customized combination module 16 generates a combination information message according to the displayed information option selected by the user. The combination information message comprises one of a volume-defining level information message, a weighting module information message, a featured-price-and-volume block comparison information message, a level-and-block comparison information message, a long-term average price display information message, a time interval display information message and a combination thereof.

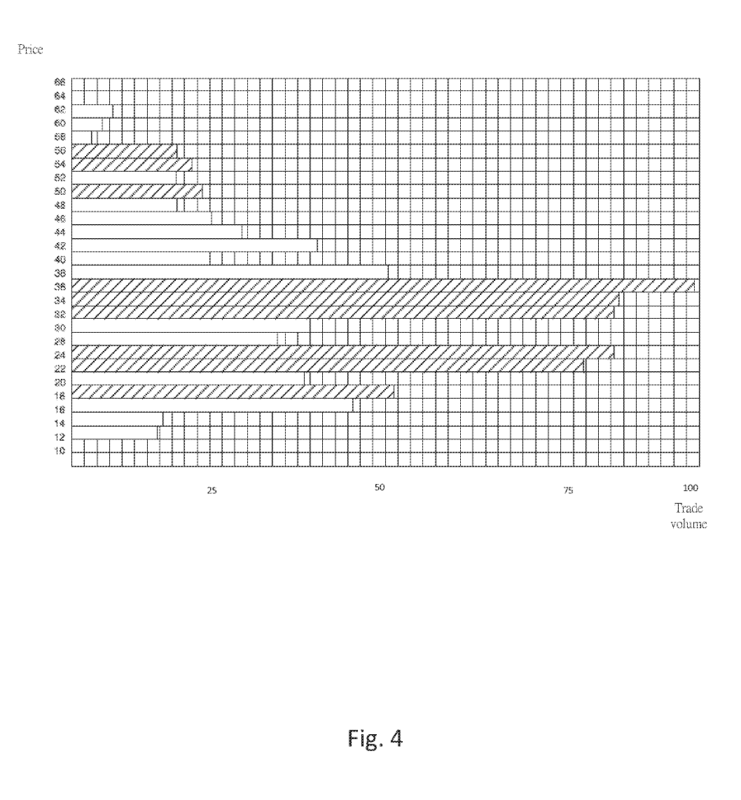

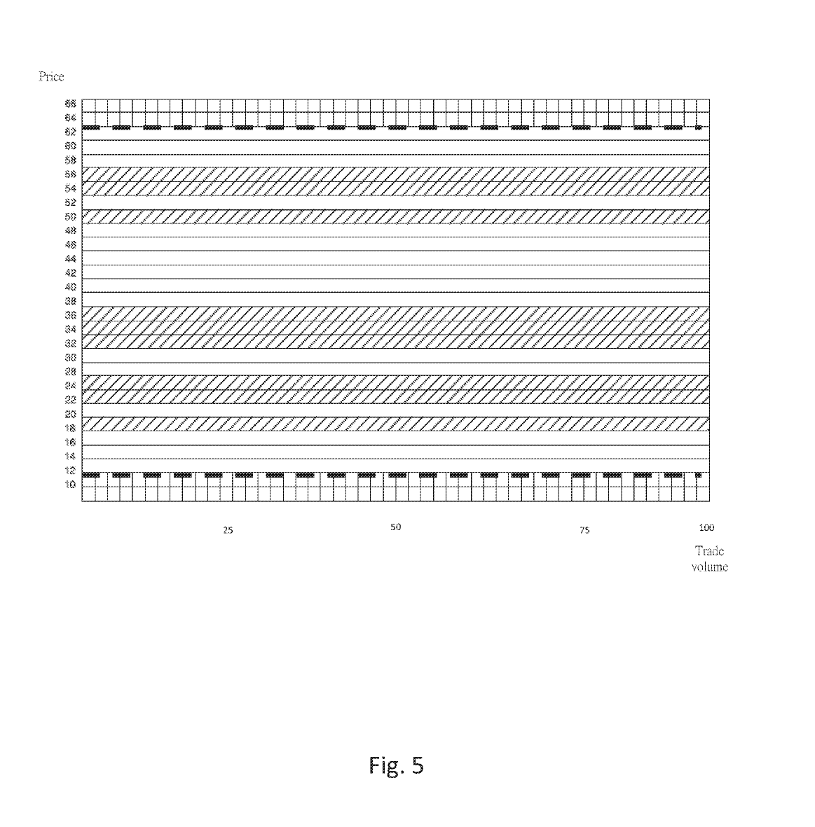

A featured-price-and-volume level module 18 is electrically connected to customized combination module 16 to receive the volume-defining level information message of the combination information message and the multiple price-and-volume information messages of the financial instruments, to determine a level of the multiple price-and-volume information messages of the financial instruments according to the information message defined in the volume-defining level information message to generate a featured-price-and-volume level information message. The volume-defining level information message comprises at least one predetermined value of a trade volume condition to define whether the multiple price-and-volume information messages are the featured price by the predetermined value of the trade volume condition. The predetermined value of the trade volume condition may be defined by the user himself/herself, or the information receiving module 14 may further constantly receive multiple historical trade data of the financial instruments, studies from these data by neural networks and machine learning and then implements recursive back tests to determine the best predetermined value of the trade volume condition for the user's reference. With reference FIG. 4, a chart shows that the feature-price-and-volume level module 18 of the present invention determine the featured price and generates featured price. In the chart each bar graphic indicates a different price interval. A length of the bar graphic indicates a trade volume. When the user is operating the customized combination module 16, according to the user's predetermined value for defining a trade volume condition, a price-and-volume information message being larger than the predetermined value of the trade volume condition is defined as a featured price. In the present embodiment, for example, the predetermined value of the trade volume condition for a price from 18 to 40 is 50, a trade volume of the predetermined value of the trade volume condition for a price from 50 to 64 is 25. Therefore, the price-and-volume information message including the trade volume over 50 for the price from 18 to 40 and the trade volume over 25 for the price from 50 to 64 will be deemed as a featured price. As shown in FIG. 4, the bar graphics with slash lines indicates the featured prices. After the featured prices are obtained, the featured-price-and-volume level module 18 may integrate the featured prices, and first quantizes the bar graphics of the feature prices and non-featured prices. In other words, the trade volume of the featured price is quantized as 100 (a full-length level bar), the trade volume of the non-featured price is quantized as 0 such that the featured-price-and-volume level information message, featured-price-and-volume level information message are generated, as shown in FIG. 5.

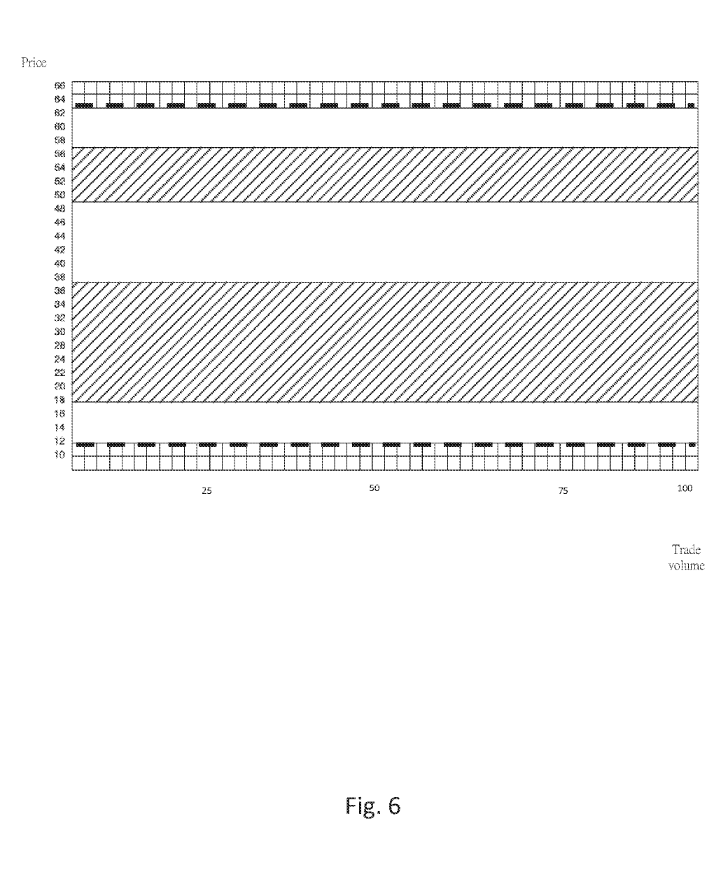

With reference to FIG. 2, the processing unit 10 further comprises a combining-and-generating module 20 electrically connected to the featured-price-and-volume level module 18 and the customized combination module 16 to second quantization according to the featured-price-and-volume level information message. In other words, the multiple featured prices level bars are combined to form at least one featured-price-and-volume block to generate at least one featured-price-and-volume block information message. With reference to FIG. 6, the present embodiment has two featured-price-and-volume blocks, the blocks with slash lines in FIG. 6. The featured-price-and-volume blocks combine with the non-featured-price-and-volume block to form the featured-price-and-volume block information message in FIG. 6. In addition to combination of two adjacent featured prices level bars into an integrated featured-price-and-volume block, the present embodiment may also allow the price-and-volume information message with at least one non-featured price located between the two featured prices, to be combined to form an integrated featured-price-and-volume block. For example, a price-and-volume level information message having two or less non-featured prices located between two featured prices level bars may be combined to form an identical featured-price-and-volume block. The featured price-and-volume level information message of the non-featured prices between the two featured prices level bars are merged to generate the featured-price-and-volume block information message. An information displaying module 21 electrically connected to the combining-and-generating module 20 and the display 12 such that a comprehensive featured-price-and-volume block chart is generated and shown on the display 12 according to the financial information message, the featured-price-and-volume level information message and the featured-price-and-volume block information message.

With reference to FIG. 2, the processing unit 10 further comprises a weighting module 22 electrically connected to customized combination module 16 and the featured-price-and-volume level module 18. Before the featured-price-and-volume level module 18 defines the featured price of the price-and-volume information message, the price-and-volumes of different trading object conditions may be weighted. In other words, each price-and-volume may have both a large number of shares per trade order (big trade order) and a small number of shares per trade order (small trade order), and the user is able to define the big order and the small order by himself/herself to give different weights to the big order and the small order. The reasons for differentiating them were the different behaviors they behaved during price movement which is essential. When the customized combination module 16 generates weighting module information message to the weighting module 22, the weighting module 22 weights and adjusts the trade volume of the price-and-volume information message. When the adjustment is implemented, a weighting value may be modified according the current advancing condition or declining condition of the financial instruments. When the price of the financial instruments decreases in the declining condition, the trade volume of the small trade order of the financial instruments is given a negative weighting setting value, and the trade volume of the big trade order of the financial instruments is given a positive weighting setting value. Then the featured-price-and-volume level module 18 defines the multiple weighted price-and-volume information messages as a featured price or a non-featured price; when a price of the financial instruments increases in the advancing condition, the trade volume of the small trade order of the financial instruments is given a positive weighting setting value, and the trade volume of the big trade order of the financial instruments is given a negative weighting setting value. Then the featured-price-and-volume level module 18 defines the multiple weighted price-and-volume information messages as a featured price or a non-featured price. The weighted price-and-volume information message, as shown in Fig., elongates or shortens the bars of the price-and-volume to be weighted, and then the featured-price-and-volume level module 18 defines a level of the multiple weighted price-and-volume information messages. The positive weighting setting value and the negative weighting setting value are both set by the user.

The processing unit 10 further comprises a time interval displaying module 28 electrically connected to customized combination module 16 and the information displaying module 21 to define and display an information of a specific time interval of the financial instruments. When the user selects the time interval in the customized combination module 16 to display, the customized combination module 16 generates time interval display information message to the time interval displaying module 28. The time interval displaying module 28 generates a time interval according to the time interval set by the time interval display information message, and transmits the time interval to the information displaying module 21 to combine with the featured-price-and-volume level information message and the featured-price-and-volume block information message to generate a comprehensive featured-price-and-volume block chart.

The processing unit 10 further comprises a featured-price-and-volume block comparing module 32 electrically connected to the customized combination module 16 and the information displaying module 21 to compare the featured-price-and-volume block information messages of the same financial instrument or the different financial instruments. When the user selects and displays a block chart similarity value in the customized combination module 16 to compare to obtain a similarity of the featured-price-and-volume block information messages(block charts) of the different financial instruments, the customized combination module 16 generates and transmits a block chart similarity value to the information displaying module 21 to combine with the featured-price-and-volume level information message, the featured-price-and-volume block information message to generate a featured price-and-volumes block chart. The featured-price-and-volume block chart comparing module employs a calculating method that calculates the similarity by cosine similarity.

The processing unit 10 further comprises a level-and-block comparing module 26 electrically connected to the customized combination module 16 and the information displaying module 21. The level-and-block comparing module 26 is able to compare to obtain a similarity of the featured-price-and-volume level information message (level bar chart) and the combined featured-price-and-volume block information message (block chart) of the same financial instrument. When the user selects and displays the similarity of the featured-price-and-volume level information message (level bar chart) and the combined comprehensive-featured-price-and-volume block information message (block chart) in the customized combination module 16, the customized combination module 16 generates a level-and-block comparison information message to the level-and-block comparing module 26. The level-and-block comparing module 26 starts to compare to obtain a similarity value of the different trade volume level information messages and the featured-price-and-volume block information messages to generate and transmit a level-and-block similarity value to the information displaying module 21 to combine with the featured-price-and-volume level information message and the featured-price-and-volume information messages to generate a comprehensive featured-price-and-volume block chart. An investor is able to determine the similarity value of the combined featured-price-and-volume block information message and non-combined featured-price-and-volume level information message according to the level-and-block similarity value to modify the reasonable combination conditions. A method for calculating the similarity value is implemented by cosine similarity.

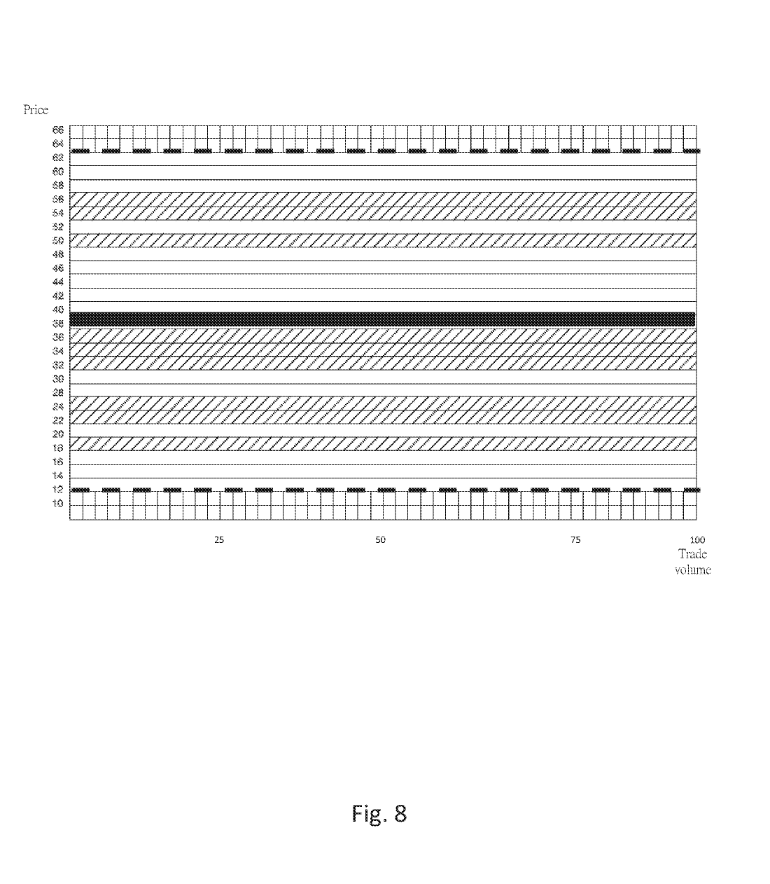

The processing unit 10 further comprises a long-term-average-price displaying module 30 electrically connected to the information receiving module 14, the customized combination module 16 and the information displaying module 21. When the user operates the customized combination module 16 to generate a long-term average price display information message to the long-term-average-price displaying module 30, the long-term-average-price displaying module 30 may generate a long-term average price information message according to financial information messages of the financial instruments of the collected information receiving module 14 and transmit the long-term average price information message to the information displaying module 21 to combine with the featured-price-and-volume block information message to generate a comprehensive featured-price-and-volume block chart. The long-term average price information message may be a year average price line, a half year average price line, a quarter average price line, etc. The long-term average price information message, as shown in FIG. 8, illustrates long-term average price in forms of bars with different colors or patterns. The present invention indicates the long-term average price information message with black bars. Furthermore, after generating long-term average price information message, the long-term-average-price displaying module 30 further transmits the long-term average price information message to the combining-and-generating module 20 such that the combining-and-generating module 20 deems the long-term average price information message as a featured price to combine with the featured price level bars to form featured-price-and-volume block.

The comprehensive featured-price-and-volume block chart generated by the information displaying module 21 is composed of any one of the information messages or a combination thereof generated by the combining-and-generating module 20, the level-and-block comparing module 26, the time interval displaying module 28, the long-term-average-price displaying module 30, and the featured-price-and-volume block comparing module 32. The chart is generated based on the user's selection to the information messages.

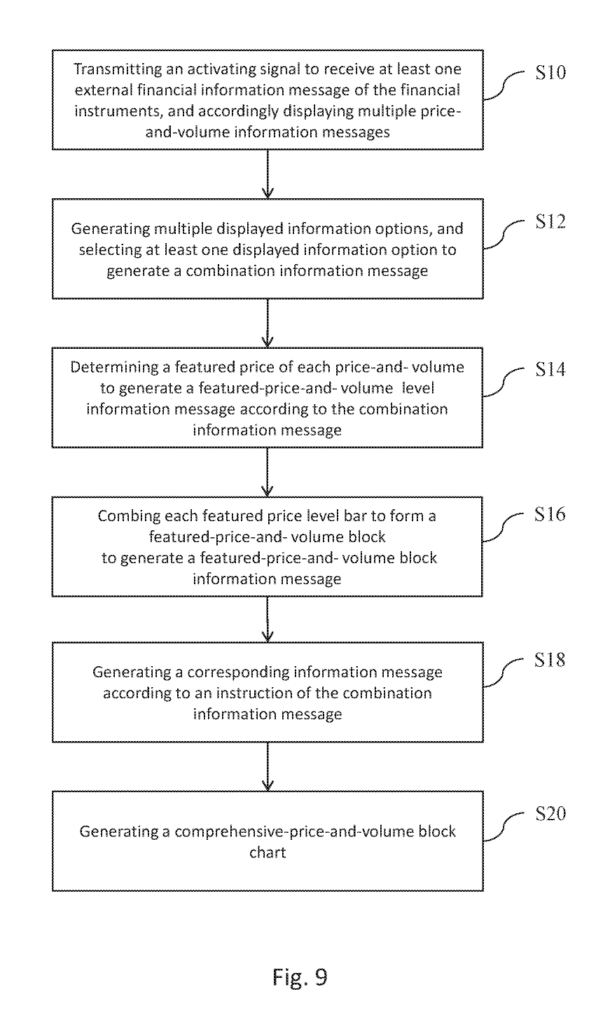

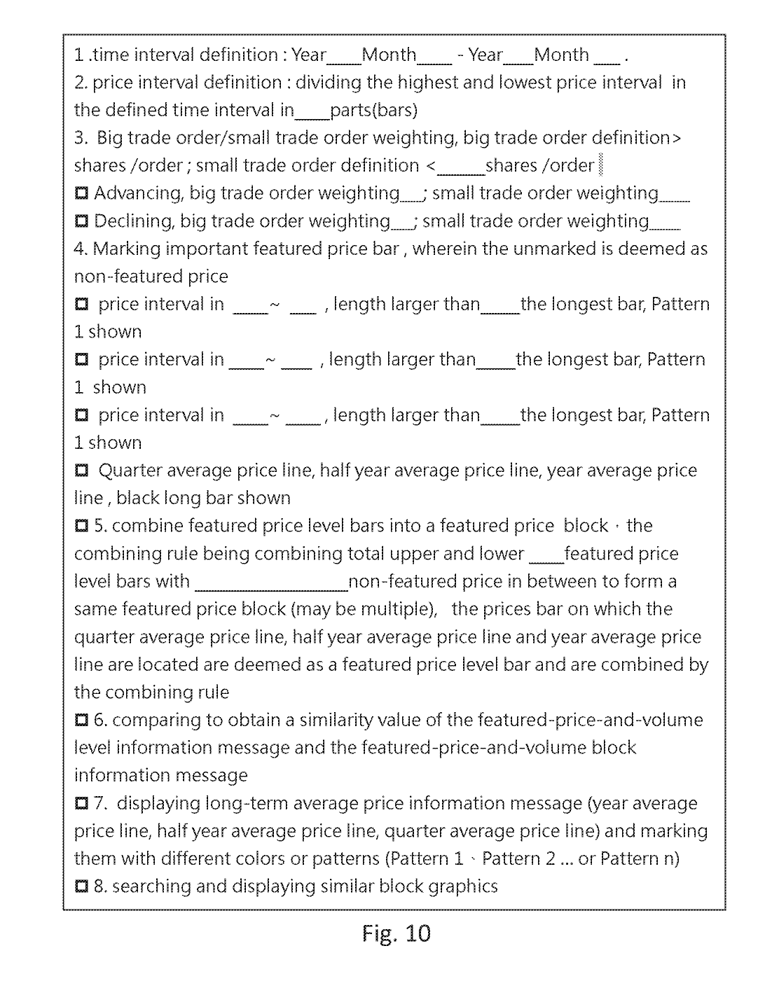

After explanation of structure of the present invention, please refer to the flowcharts of FIGS. 2 and 9. As shown in the figures is a trade data processing method for financial instruments. First, a step S10 is implemented, computer 1 is operated to transmit an activating signal, the information receiving module 14 starts to receive financial information message of at least one external financial instrument according to the activating signal, and multiple price-and-volume information messages of the financial instruments are displayed according to the financial information message; then a step S12 is implemented, the customized combination module 16 generates and displays multiple displayed information options in the display 12. The way that the multiple displayed information options are displayed in the display 12 is shown in FIG. 10 to allow a user to select at least one of the displayed information options to generate a combination information message such that a trade volume-defining level information message, a weighting module information message, a featured-price-and-volume block comparison information message, a level-and-block comparison information message or a long-term average price display information message is accordingly generated according to the selected information option. For example, a definition of the present invention is as follows. With reference to FIG. 10, when the step S12 is implemented: First, Field 1 is selected, and a time interval from 2014/09 to 2016/03 is defined; Field 2 is selected, and a price interval of the financial instruments illustrated is between 10-66 and is divided into 30 equal parts; Field 3 is selected, weighting is performed according to the big trade order or small trade order of the financial instruments, and the user is able to define the big trade order and the trade small order with different weights; Field 4 is selected, and it is defined that in a price interval a price being larger than a predetermined value of a trade volume condition is set as a featured price. For example, the present embodiment defines that a trade volume of a predetermined value of a trade volume condition for a price from 18 to 40 being 50 is illustrated as a featured price, and the featured price is illustrated in form of Pattern 1. Furthermore, a trade volume of a predetermined value of a trade volume condition for a price from 50 to 64 being 25 is illustrated as a featured price, and the featured price is illustrated in form of Pattern 1; Field 5 is selected, five adjacent featured prices level bars with two intervening non-featured prices are combined to form a block (multiple blocks are available), and the quarter average price line, half year average price line or year average price line are deemed as a featured price and combined with the combining rule; and Field 7 is selected, and the long-term average price information messages (the year average price line, half year average price line and quarter average price line) are illustrated with marks of different patterns (Pattern 1, Pattern 2 . . . and Pattern n), and the long-term-average-price displaying module 30 is able to generate a long-term average price information message according to financial information messages of the financial instruments.

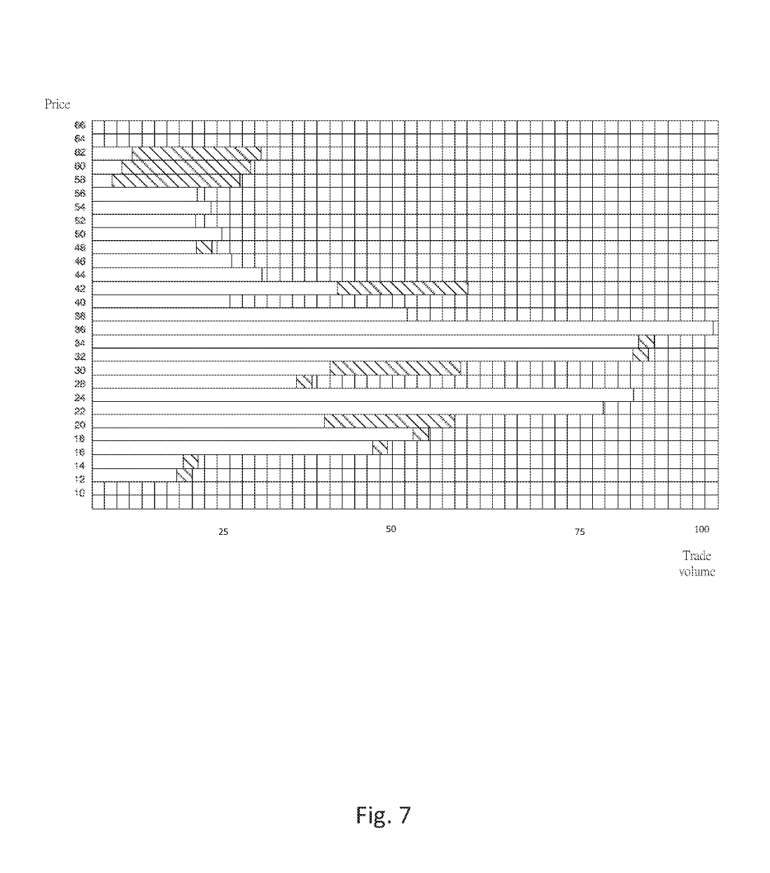

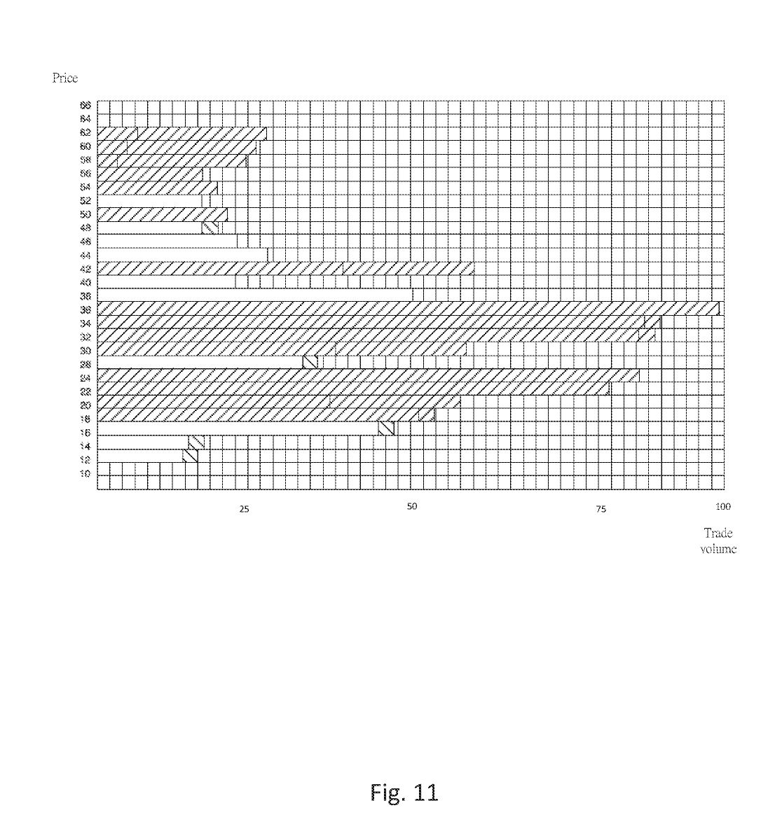

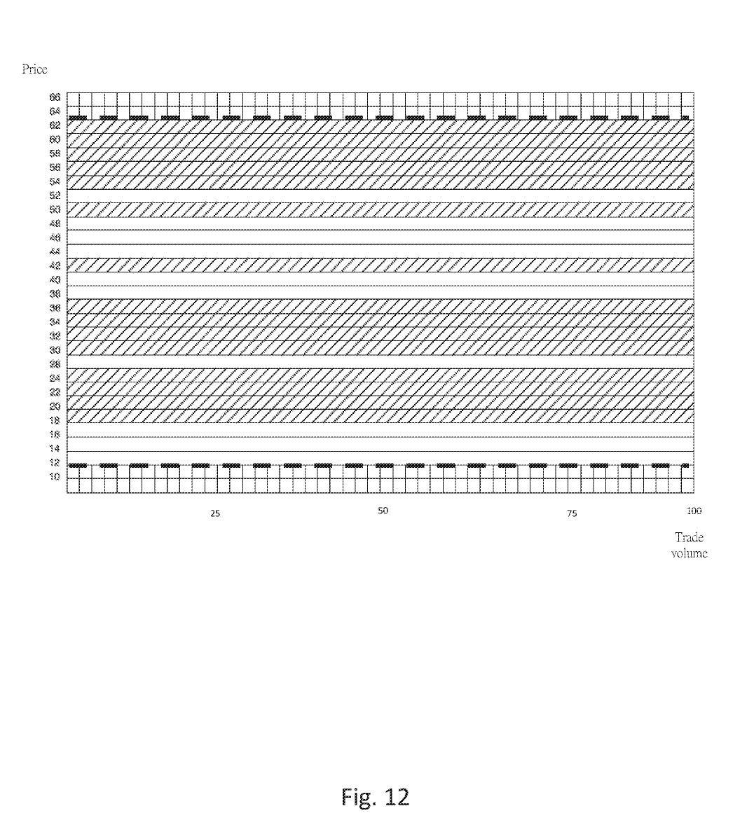

Then the step S14 is implemented. The featured-price-and-volume level module 18, according to the predetermined value of the trade volume condition of the trade volume-defining level information message of the combination information message, determines whether the price-and-volume information message is a featured price to generate featured-price-and-volume level information message. Because the case of the present embodiment performances the weighting process in advance, as shown in FIG. 7, the featured-price-and-volume level module 18 therefore determines according to the weighted price-and-volume information message. The present embodiment defines that a trade volume of a predetermined value of a trade volume condition for a price from 18 to 40 is 50 and a trade volume of a predetermined value of a trade volume condition for a price from 50 to 64 is 25. A determined featured price is shown in FIG. 11, and the bar graphics pertinent to the featured price are painted with Pattern 1. The featured-price-and-volume level module 18 then integrates and quantizes the featured price level bars to generate a featured-price-and-volume level information message (level bar chart). The featured-price-and-volume level information message is shown in FIG. 12, and a first quantization process is completed.

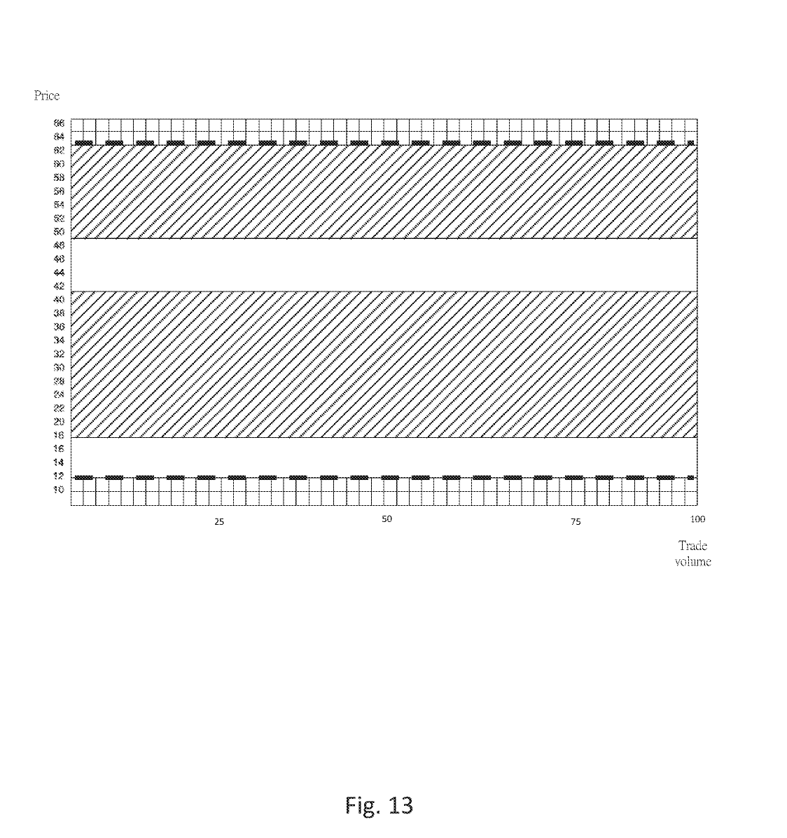

Then the step S16 is implemented. A second quantization process is implemented. The combining-and-generating module 20 combines the multiple featured price level bars to form at least one featured-price-and-volume block according to the aforementioned conditions. The example of the present embodiment defines that during the implementation of the step S12, Field 5 is selected, and five adjacent featured prices level bars with two intervening non-featured prices are combined to form a block (multiple blocks are available), and the quarter average price line, half year average price line or year average price line are deemed as a featured price and combined with the combining rule. Therefore, the featured-price-and-volume block information message (block chart) is presented as in FIG. 13. In other words, when a number of the featured prices level bars adjacent to the non-featured prices are totally five, two or less non-featured prices are combined and dismissed. During the process, first, one of the non-featured prices between the adjacent featured prices level bars is combined to form a featured-price-and-volume block, and then two adjacent non-featured prices between the adjacent featured prices level bars are combined to form a featured-price-and-volume block to generate a combined featured-price-and-volume block information message. Moreover, a number of the non-featured prices between the adjacent featured prices level bars may be determined by the combining-and-generating module 20 according to a number of price-and-volume information messages of the financial instruments. The more the number of the price-and-volume information messages is, the more the combined non-featured prices are. Furthermore, a number of the featured prices level bars adjacent to the combined non-featured price is more. For example, when a number of the price-and-volume information message intervals of the financial instruments is 100, the combined non-featured prices are five or less. However, a number of the featured prices level bars adjacent to the combined non-featured prices must be seven or more.

Then the step S18 is implemented. A corresponding information message is generated according to an instruction of the combination information message generated from the selected displayed information option in the aforementioned step S12. Furthermore, when Field 6 is selected in the definition interval of the step S12 to compare to obtain a similarity of the featured-price-and-volume level information message and featured-price-and-volume block information message, a featured-price-and-volume block is generated after the step S14 and step S16, and in the step S18 the level-and-block comparing module 26 is able to timely generate a similarity comparing the featured-price-and-volume level information message(level bar chart) the featured-price-and-volume block information message(block chart) to generate a level-and-block similarity value. The comparing method has been described as above and will not be repeated. When Field 8 is selected in the definition interval of the step S12 to find out and classify similar graphic financial instruments, in other words, similarity of the featured-price-and-volume block information messages of the different financial instruments is displayed and compared, a featured-price-and-volume block is generated after the step S14 and the step S16, the step S18 is able to timely generate a block similarity value by the featured-price-and-volume block comparing module 34 to compare to obtain a similarity of the featured-price-and-volume block information message of the different financial instruments. The comparing method has been described as above and will not be repeated.

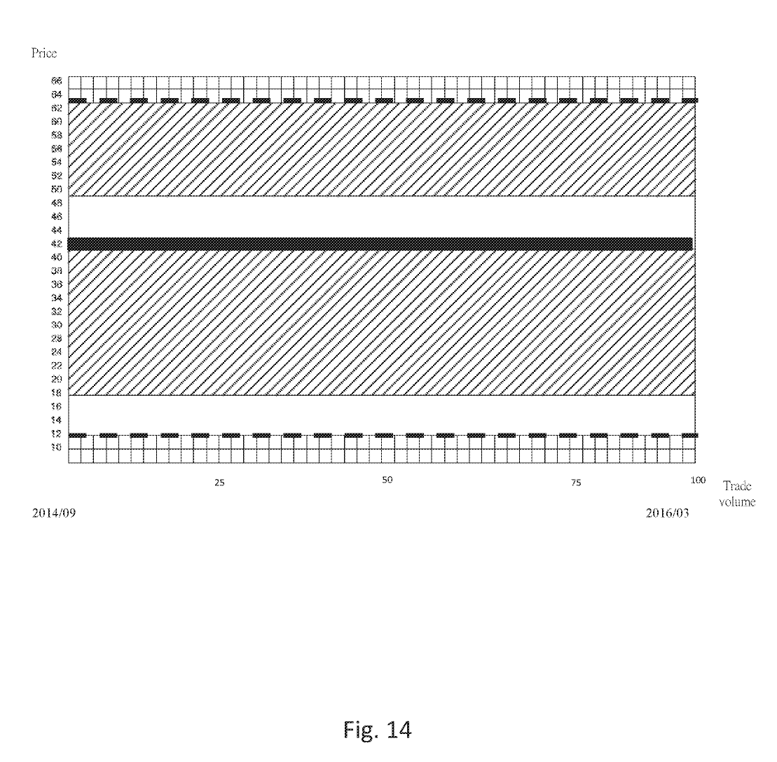

Then the step S20 is implemented. A combination is implemented according to the information messages selected by the user to generate a comprehensive featured-price-and-volume block chart. According to the contents as defined by the aforementioned embodiments, the comprehensive featured-price-and-volume block chart finally displayed in the display 12 by the present embodiments is shown in FIG. 14. Alternatively, the chart may be composed of any one of the information messages or a combination thereof generated from the weighting module 22, the level-and-block comparing module 26, the time interval displaying module 28, the long-term-average-price displaying module 30, and the featured-price-and-volume block comparing module 32.

As described above, the present invention synchronously combines the past information messages of historical trade price and historical trade volume of the financial instruments that takes completely two-dimensional data into account. By two quantization processes, the two-dimensional data is turned into a featured-price-and-volume block information message. The featured-price-and-volume block information message indicates a consolidation period of price fluctuation of the financial instruments. In such period the price fluctuation indicates stalemate and chaos. When the price fluctuation of the financial instruments is escaping from the featured-price-and-volume block, the consolidation period condition, the price movement of the financial instruments is effectively determined no matter which of a start point or stop point of an advancing trend or declining trend the price movement undergoes, which facilitates an investor to read the information, effectively assists the investor and enhances investing profit of the financial instruments.

The aforementioned description is merely preferred embodiments of the present invention and are not used to limit the scope of the present invention. Therefore, any equivalent variation or modification complying with the features and the spirits of the claims of the present invention should be included scope of the claims of the present invention.

What is claimed is:

1. A trade data processing device for financial instruments applied to a computer with a display, the trade data processing device for financial instruments comprising:
an information receiving module receiving a financial information message of at least one external financial instrument;
a price-and-volume displaying module displaying the multiple price-and-volume information messages of the financial instruments according to the financial information message;
a customized combination module generating multiple displayed information options and displaying the multiple displayed information options in the display to allow a user to select at least one displayed information option to generate a combination information message, wherein the combination information message comprises a volume-defining level information message;
a featured-price-and-volume level module receiving the multiple price-and-volume information messages, and defining the price-and-volume information message being larger than a predetermined value of a trade volume condition as a featured price to generate a featured-price-and-volume level information message according to the volume-defining level information message of the combination information message;
a combining-and-generating module combining the multiple featured prices level bars of the featured-price-and-volume level information message into at least one featured-price-and-volume block to generate a featured-price-and-volume block information message; and
an information displaying module generating and displaying a comprehensive featured-price-and-volume block chart in the display according to the financial information message, the featured-price-and-volume level information message, and the featured-price-and-volume block information message.

2. The trade data processing device for financial instruments as claimed in claim 1, wherein the combination information message further comprises a weighting module information message, a featured-price-and-volume block comparison information message, a level-and-block comparison information message, a long-term average price display information message or a time interval display information message.

3. The trade data processing device for financial instruments as claimed in claim 2 further comprising a weighting module, wherein when the customized combination module generates the weighting module information message to weighting module, the weighting module weights and adjusts a trade volume of the price-and-volume information message, when a price of the financial instruments decreases, the weighting module gives a negative weighting setting value to a trade volume of a small trade order of the financial instruments and gives a positive weighting setting value to a trade volume of a big trade order of financial instruments, then the featured-price-and-volume level module defines the multiple weighted price-and-volume information messages; when the price of the financial instruments increases, the weighting module gives a positive weighting setting value to a trade volume of a small trade order of the financial instruments and gives a negative weighting setting value to a trade volume of a big trade order of financial instruments, then the featured-price-and-volume level module defines the multiple weighted price-and-volume information message.

4. The trade data processing device for financial instruments as claimed in claim 2 further comprising a time interval displaying module, wherein when the customized combination module generates time interval display information message to the time interval displaying module, a time interval is generated and transmitted to the information displaying module according to a time interval set by the time interval display information message.

5. The trade data processing device for financial instruments as claimed in claim 2 further comprising a featured-price-and-volume block chart comparing module, wherein when the customized combination module generates the featured-price-and-volume block charts comparison information message to the featured-price-and-volume block comparing module, similarity value of the different featured-price-and-volume block information messages is obtained by comparison to generate and transmit a block chart similarity value to the information displaying module.

6. The trade data processing device for financial instruments as claimed in claim 2 further comprising a level-and-block comparing module, wherein when the customized combination module generates the level-and-block comparison information message to the level-and-block comparing module, similarity of the different featured-price-and-volume level information messages and the featured-price-and-volume block information messages is obtained by comparison to generate and transmit a level-and-block similarity value to the information displaying module.

7. The trade data processing device for financial instruments as claimed in claim 2 further comprising a long-term-average-price displaying module, wherein when the customized combination module generates the long-term average price display information message to long-term-average-price displaying module, the long-term-average-price displaying module generates and transmits a long-term average price information message to the information displaying module.

8. The trade data processing device for financial instruments as claimed in claim 7, wherein after the long-term-average-price displaying module generates long-term average price information message, the long-term average price information message is further transmitted to the combining-and-generating module to combine the long-term average price information message and the featured prices level bars to form the featured-price-and-volume block.

9. The trade data processing device for financial instruments as claimed in claim 1, wherein the combining-and-generating module combining the multiple featured prices level bars to form the featured-price-and-volume block combines adjacent featured prices level bars or combines two featured prices level bars between which at least one non-featured price is located to generate a featured-price-and-volume block information message.

10. The trade data processing device for financial instruments as claimed in claim 1, wherein the financial instruments are stocks, currency, bonds, options, futures, exchange traded funds or interest rates.

11. A trade data processing method for financial instruments comprising steps as follows:
generating an activating signal and starting to receive at least one external financial information message according to the activating signal, and displaying multiple price-and-volume information messages of the financial instruments according to the financial information message;
generating multiple displayed information options to select at least one displayed information option, generating a combination information message comprising a volume-defining level information message;
defining the price-and-volume information message being larger than a predetermined value of a trade volume condition as a featured price to generate a featured-price-and-volume level information message according to the volume-defining level information message;
combining the multiple featured prices level bars to form at least one featured-price-and-volume block to generate at least one featured-price-and-volume block information message; and
generating a comprehensive featured-price-and-volume block chart according to the financial information message, the featured-price-and-volume level information message and the featured-price-and-volume block information message.

12. The trade data processing method for financial instruments as claimed in claim 11, wherein before the step (c), weighting and adjusting a trade volume of the price-and-volume information message, when a price of the financial instruments decreases, a negative weighting setting value is given to a trade volume of a small trade order of the financial instruments and a positive weighting setting value is given to a trade volume of a big trade order of financial instruments; when the price of the financial instruments increases, a positive weighting setting value is given to a trade volume of a small trade order of the financial instruments and a negative weighting setting value is given to a trade volume of a big trade order of financial instruments.

13. The trade data processing method for financial instruments as claimed in claim 11, wherein after the step (d), setting a time interval to display the time interval.

14. The trade data processing method for financial instruments as claimed in claim 11, wherein after the step (d), comparing to obtain a similarity of the featured-price-and-volume block information messages of the different financial instruments to generate a block chart similarity value to display the block charts similarity value.

15. The trade data processing method for financial instruments as claimed in claim 11, wherein after the step (d), comparing to obtain a similarity of the featured-price-and-volume level information message and the featured-price-and-volume block information message to generate a level-and-block similarity value and display the level-and-block similarity value.

16. The trade data processing method for financial instruments as claimed in claim 11, wherein before the step (d), generating a long-term average price information message then implementing the step (d) to combine the long-term average price information message and the featured prices level bars to form the featured-price-and-volume block information message.

17. The trade data processing method for financial instruments as claimed in claim 11, wherein after the step (d), generating a long-term average price information message and displaying the long-term average price information message.

18. The trade data processing method for financial instruments as claimed in claim 11, wherein the step (d) combining the featured prices level bars to from the at least one featured-price-and-volume block combines adjacent featured prices level bars or combines two featured prices level bars between which at least one non-featured price is located to generate a featured-price-and-volume block information message

19. The trade data processing method for financial instruments as claimed in claim 11, wherein the financial instruments are stocks, currency, bonds, options, futures, exchange traded funds or interest rates.
